(19) United States
(12) Patent Application Publication
(10) Pub. No.: US 2012/0184257 A1
(43) Pub. Date: Jul. 19, 2012

(54) Multiparty lines Communication Method

(75) Inventors: Cheng-Jen Yang, Hukou Township (TW); Yung-Hua Chao, Hukou Township (TW)

(73) Assignee: Browan Communications, Inc., Hukou Township (TW)

(21) Appl. No.: 13/094,831

(22) Filed: Apr. 27, 2011

(30) Foreign Application Priority Data
Jan. 14, 2011 (TW) 100101467

(51) Int. Cl. H04W 4/00; H04M 3/42

(52) U.S. Cl. 455/416; 379/202.01

(57) ABSTRACT

A multiparty communication management method employs an initiative computer device to initiate a multiparty communication for connecting to plural receiving communication devices. Next, any receiving communication devices is employed to call an initiative communication device via the user interface or DTMF, whereby the initiative communication device is joined the multiparty lines communication. Finally, the initiative computer device can directly control the voice signals of any of receiving communication devices. By aforementioned method, conferees of the multiparty communication can request the initiator to manage the communication instead of redundant commands required in the art, thereby providing a multiparty communication management method with higher operation rate and greater convenience.

### CROSS REFERENCE TO RELATED APPLICATION

This present application claims priority to TAIWAN Patent Application Serial Number 100101467, filed on Jan. 14, 2011, which are herein incorporated by reference.

### TECHNICAL FIELD

The present invention generally relates to a communication method, in particular to a communication system and method of multiparty lines.

### DESCRIPTION OF THE RELATED ART

The data transfer and exchange are indispensable power to promote the industry to progress all the time. In recent years, followed by the development of the telecommunication products and technology, and the flourish of the internet, the communication method between people is significantly ameliorated. In currently existing communication technology, people can choose an interoffice phone, a cell phone, real-time communication software, an internet telephone, and so on, to execute voice communication, so that the data can be transferred simultaneously.

In the past telecommunication network, there are only two users capable of processing dual-way communication in one call. However, in the business-oriented modern society, the businessman often has to hold a multiparty conference with many clients, suppliers, or cooperators at different places, and it's obvious that the dual-way communication in one call by only two users cannot meet aforementioned requirement.

In order to meet the requirement of the multiparty lines communication or the conference call, a communication system is subsequently developed, which can provide the user to simultaneously connect more than two remote users for constructing a multiparty lines call. For satisfying the function of multiparty lines communication or the conference call, the communication device has to provide a mechanism for the user to initiate and manage the multiparty lines communication. In a general portable communication device corresponding to GSM protocol, including a cell phone, a smart phone, or a PDA, it is defined by GSM protocol that there can be two established calls and one waiting call at most in the meanwhile. One of the established calls is active, and another one is held. Only one of aforementioned calls can be the conference call or the multiparty call.

Continuing with aforementioned description, because there is only one active call in the general mobile communication protocol, if the speaker desires to initiate a multiparty call or a conference call, he has to contact the receivers one by one, for respectively asking them to transmit their voice signals into the mixing gateway, whereby processing the conference call. Nevertheless, if there are many receivers, the speaker has to spend much time to contact them one after another, and that is not only redundant and time-consuming, but also takes much money for the user in communication. Moreover, traditional multiparty call may require to be redialed owning to mistakes or faults caused by the speaker, such as keying in wrong telephone numbers. That is, every successfully contacted receiver is required to be re-contacted. Therefore, it is such a violent torture for the speaker's patient and circumspection to initiate a traditional multiparty call, and that is really inconvenient.

Besides, if the speaker would like to manage the conference, such as: banishing some receivers, muting some receivers, or amplifying, decreasing the volume, etc, when the traditional multiparty call is processing, it has to press some combinations of buttons of the communication device, ex: #13#, *123*, #95*, or*77#, etc, so as to be the commands of aforementioned management. However, such method mentioned above is pretty complicated, and not unfavorable for instinct. Additionally, if the speaker presses a wrong button of the command by accident, the command is failed to be inputted, which causes that the user has to re-enter the correct command, so that it is quite inconvenient for operating and using.

In view of aforementioned description, it has to take much time and money for contacting the receivers of the multiparty call, or managing the conference of the multiparty call. And it certainly wastes cost without doubt for those businessmen or senior managers. Thus, there are some difficulties and shortcomings still existing in the typical multiparty lines communication to be overcome.

### SUMMARY

In view of the foregoing, the present invention discloses a communication method, and more specifically, it's relevant to a system and a method of the multiparty call, so as to overcome aforementioned difficulties and shortcomings.

One purpose of the present invention is to provide a time-saving and convenient multiparty call. When a businessman desires to launch a multiparty call, he can call or contact the secretary or the assistant in front of a computer to use that computer initiating a multiparty call. Additionally, if the conferee wants to manage the conference as the conference call is processing, he can call aforementioned secretary or assistant to use aforementioned computer for managing the multiparty call. Hence, the obsession in the typical conference call that has to keep the complicated combinations of buttons in the user's mind or enters faulty buttons can be eliminated.

Another purpose of the present invention is to provide a convenient method of multiparty call, which employs a smart phone or a computer to raise a multiparty call command that can contact a plurality of receivers simultaneously, whereby omitting the time required for individually calling every receiver in the prior art.

In order to accomplish aforementioned purposes, the present invention discloses a method for managing a multiparty call, and the steps are described in the following. First, the multiparty call is initiated by a initiative computer, whereby connecting a plurality of receiving communication devices; and then, a initiative communication device is called by any of the receiving communication devices, for making the initiative communication device join the multiparty call; and eventually, and the voice signals of any of receiving communication devices are controlled by the initiative computer. By aforementioned features, the conferee doesn't require to key in complicated combinations of buttons for managing the conference, and instead, it is just required to introduce DTMF (Dual-Tone Multi-Frequency) or the user interface of the smart phone for connecting the initiative communication device, such as the phone of the secretary or the assistant, so that the secretary or the assistant can be instructed to use the initiative computer to control the voice signals of each conferee, thereby achieving the purpose of managing the conference.

In another aspect, the present invention also discloses a method for managing a plurality of conference calls, and the steps are describes as follows. First, a plurality of conference calls are initiated by an initiative computer, whereby connecting a plurality of receiving communication devices groups; and subsequently, an initiative communication device is called by a receiving communication device in any one of the receiving communication devices groups, whereby making the initiative communication device join corresponding conference call; and last, voice signals of any one of the receiving communication devices are directly controlled by the initiative computer.

The advantage of the present invention is that the businessman can raise one or many conference calls by the secretary or the assistant through a computer. Moreover, the conferee of each conference call can contact the initiator of the conference (namely, the secretary or the assistant) as desiring to manage the conference, and can instruct the initiator to control voice signals of each conferee by the remote computer, instead of inputting various combinations of buttons in the well-known managing method of the multiparty call. Thus, aforementioned method not only saves the time required for inputting the combinations of buttons, bus also eliminates the harassment of inputting wrong button or the requirement of keeping those combinations in mind, so that the multiparty calls can be managed more effectively and efficiently.

Aforementioned description is to illustrate purposes of the present invention, technical characteristics to achieve the purposes, and the advantages brought from the technical characteristics, and so on. And the present invention can be further understood by the following description of the preferred embodiment accompanying with the claims.

### BRIEF DESCRIPTION OF THE DRAWINGS

FIG. 1 shows the system diagram of one embodiment of the present invention;

FIG. 2 shows the flow chart of one embodiment of the present invention;

FIG. 3 shows the flow chart of one embodiment of the present invention;

FIG. 4 shows the flow chart of another embodiment of the present invention.

### DETAILED DESCRIPTION

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims.

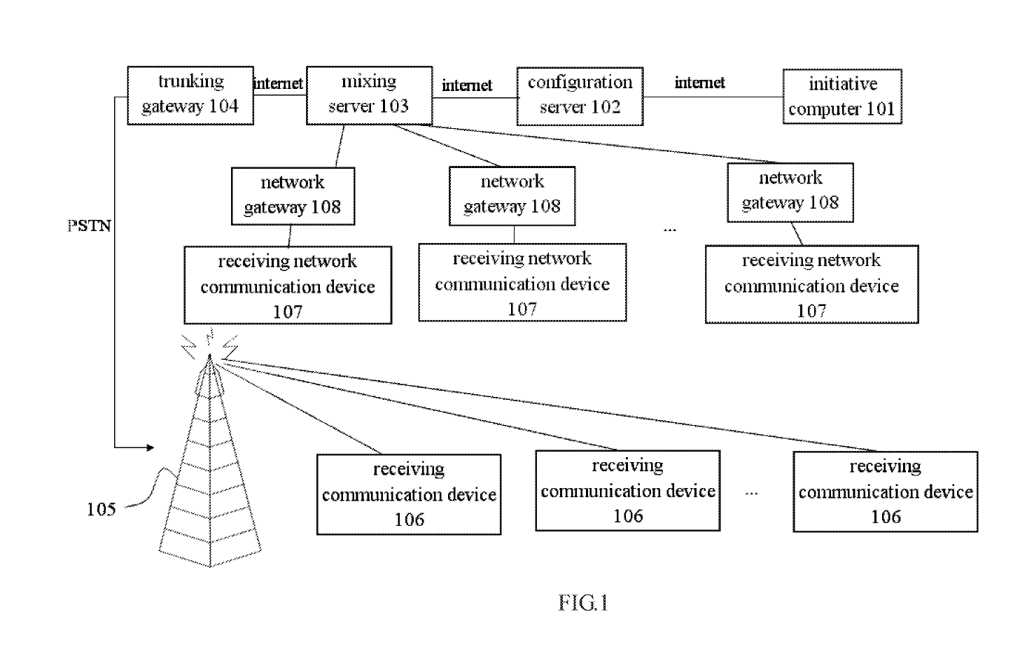

The communication system disclosed by the present invention for the multiparty call can be referred to FIG. 1. In this figure, the initiative computer 101 is connected to the configuration server through internet, for facilitating to transmit a multiparty call command. Aforementioned computer may include, but is not limited to, a PC, a notebook, or a tablet PC, etc. The computer may comprise a wired network module, such as the interface compatible with cat.5 cat.5e, or cat.6; or, it may also comprise a wireless network module compatible with LAN (local area network) or MAN (metropolitan area network), such as: Wi-Fi module, 802.11x (x means a, b, g, or n) module, or WiMAX (Worldwide Interoperability for Microwave Access) module, etc. By aforementioned network modules, the initiative computer 101 can transmit the multiparty call command to the configuration server 102. In this case, aforementioned multiparty call command is generated by integrating a plurality of phone numbers through the software or program in the initiative computer 101 controlled by the initiator. For instance, particular persons can be selected from the address book software application, and their phone numbers can be integrated as a multiparty call command. Subsequently, every receiver can be contacted or connected simultaneously by transmitting aforementioned command. In another aspect, the phone numbers of the plural receivers can also be directly inputted in the computer, followed by being integrated as a multiparty call command.

The configuration server 102 is connected to the mixing server 103 via internet for requesting the mixing server 103 to launch the multiparty call. Moreover, the configuration server 102 may also confirm whether aforementioned phone numbers are available or not by the software or program in the configuration 102. The mixing server 103 can connected to the trunking gateway 104 and various network gateways 108 via internet. Besides, if the receiver employs a network communication device 107 compatible with the general SIP (Session Initiation Protocol), the mixing server can also be directly connected to the network communication device 107 via internet without through the internet gateway 108. The voice signals from the initiative communication device 109, plural receiving communication devices 106, and plural receiving network communication devices 107 can be mixed or synthesized by the mixing server 103, so that every user of aforementioned devices can hear voices of each other, thereby achieving the purpose of multiparty call or the conference call. In such case, each of the various network gateways 108 conforms to the communication protocol of the corresponding network communication device 107. For example, if the receiving introduces the google talk software as the communication device, the corresponding network gateway has to comply with the communication protocol of google talk, whereby converting the signals of google talk to SIP signals generally applied in the network phones, so as to facilitate the mixing server 103 to mix those signals. Other types, such as skype, can also employ the corresponding network gateway (ex: the skype gateway) for connecting. Therefore, the receiving network communication device is not limited to the VoIP phone compatible with SIP protocol, instead, it can further comprise the softphone such as google talk or skype. Additionally, if the receiver owns accounts of different softphones, ex: owning accounts of google talk and skype in the mean time, the mixing server 103 can determine the dialing sequence according to the multiparty call command. For instance, the mixing server 103 can call the number of skype prior to which of google talk.

One port of the trunking gateway 104 is connected to internet, and another port is connected to PSTN. The trunking gateway 104 can convert the digital signals of internet to the telecommunication signals compatible with PSTN. In the contrary, the telecommunication signals compatible with PSTN can also be converted to the digital signals of internet. Thus, the trunking gateway 104 can play the role of bridging the internet and PSTN, so that the internet data of the multiparty call command transmitted by the mixing server 103 can be converted to data compatible with PSTN through the trunking gateway 104. The trunking gateway 104 can transmit the multiparty call command to a telecommunication base station 105 through PSTN, and subsequently, the telecommunication base station 105 can contact the receiving communication devices 106 corresponding to the selected phone numbers through the communication channel. Any ordinary person skilled in the art should understand that the communication channel may include the wired channel and the wireless channel. If the receiving communication device 106 is a wired phone, such as: a local telephone, the wired channel can be introduced to connect it; if the receiving communication device 106 is a wireless communication device, such as a cell phone, a smart phone, or a PDA, the wireless channel can be introduced to connect it. Definitely, those receiving communication devices 106 may both comprise wired communication devices and wireless communication devices, and in this case, the telecommunication base station 105 can connect aforementioned devices via the wired channel and the wireless channel simultaneously. The voice signals of the initiative communication device 109 and all of the receiving communication devices 106 can be transmitted to the mixing server 103 for mixing or synthesizing as the telecommunication base station 105 successfully connects the receiving communication devices 106, whereby facilitating to execute the multiparty call without respectively calling those receiving communication devices 106 by the initiative communication device 109. It has to be noted that the initiator raising the multiparty call by the computer 101 in the embodiment may just be an initial emcee, not a conferee, thus, the initiative communication device 109 may not participate the conference, or be kept in the conference throughout. For example, the initiator may be the secretary or the assistance of some receiver, and when the receiver requests the initiator to raise a multiparty call for facilitating to hold a conference with clients, cooperators, or executers, etc, the initiator can send a multiparty call command by the initiative computer 101 to receiving communication devices 106. When every receiving communication device 106 is connected successfully, the initiator can transmit voice to the mixing server 103 by the initiative communication device 109 for mixing and then facilitating to emcee the conference. Afterwards, when the conference is processing, the connection between the initiative communication device 109 and the mixing server 103 can be cut off, so as to assist the confidentiality of the conference call.

Further, the receiver can also employ the receiving network communication devices 107, such as an internet phone, a Wifi cell phone, or a softphone. It is noted that aforementioned receiving network communication device 107 has to comply with VoIP (Voice over Internet Protocol), whereby facilitating the voice communication through internet. When the receiving network communication device 107 complies with SIP, it can be directly connected to the mixing server 103 for transmitting voice messages; when the receiving network device 107 doesn't comply with SIP, such as the softphone of google talk or skype, the corresponding network gateway 108 can be introduced to connect the receiving network communication device 107 to the mixing server 103. Thus, voice messages form various receiving communication devices 106 or receiving network communication devices 107 can be mixed, so as to facilitate the multiparty call. Accordingly, the communication device employed by the receiver may include, but is not limited to, a wired phone, a cell phone, a smart phone, a internet phone, a Wifi cell phone, or a softphone.

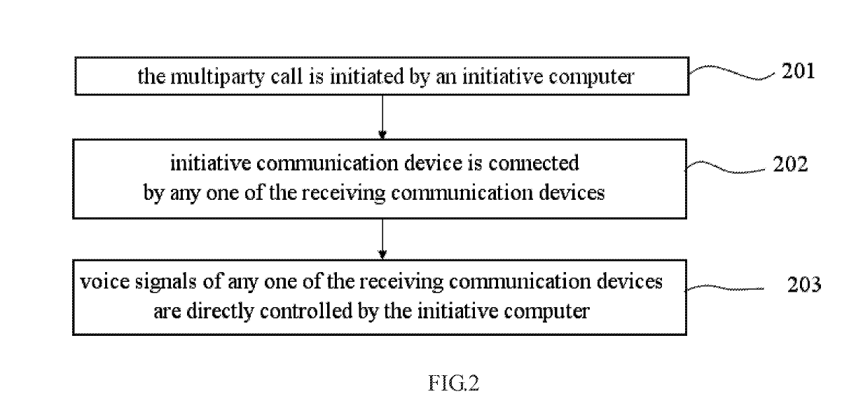

Referred to FIG. 2, it shows the preferred embodiment of the method for managing the multiparty call of the present invention, which comprises the steps as follows. At First, in the step 201, the multiparty call is initiated by an initiative computer for connecting plural receiving communication devices, wherein the operation method of the multiparty call is disclosed hereinafter. And then, in the step 202, an initiative communication device is connected by any one of the receiving communication devices so as to allow aforementioned initiative communication device to join the multiparty call. Specifically, the receiver can operate the communication device by DTMF (Dual-Tone Multi-Frequency) technology to contact the initiative communication device. Alternatively, if the receiver employs the smart phone or the PDA, the initiative communication device can be called by directly entering the command via the interface. Finally, in the step 203, the voice signals of any one of the receiving communication devices are directly controlled by the initiative computer. By aforementioned method, the conferee doesn't need to input complicated combinations of buttons for managing the conference, instead, the conferee just need to employ DTMF technology or the interface of the smart phone to call the initiative communication device, such as the phone of the secretary or the assistant, so that the secretary or the assistant can be instructed to use the initiative computer to control the voice signals of every conferee, thereby achieving the purpose of managing the conference.

For example, when the conferee would like to manage the conference, he (or she) can call the secretary or the assistant directly, and ask the secretary or the assistant to directly control the voice signals of any one of the receiving communication devices. For instance, the software or the program in the initiative computer can be introduced to control voice signals, such as: stopping, pausing, amplifying, decreasing, or muting the voice signals. Hence, the conferee can manage the conference effectively and efficiently instead of inputting complicated combinations of buttons. In some embodiments, if the receiving communication device is a smart phone or a PDA, the interface thereof can be used to directly control voice signals of other receiving communication devices.

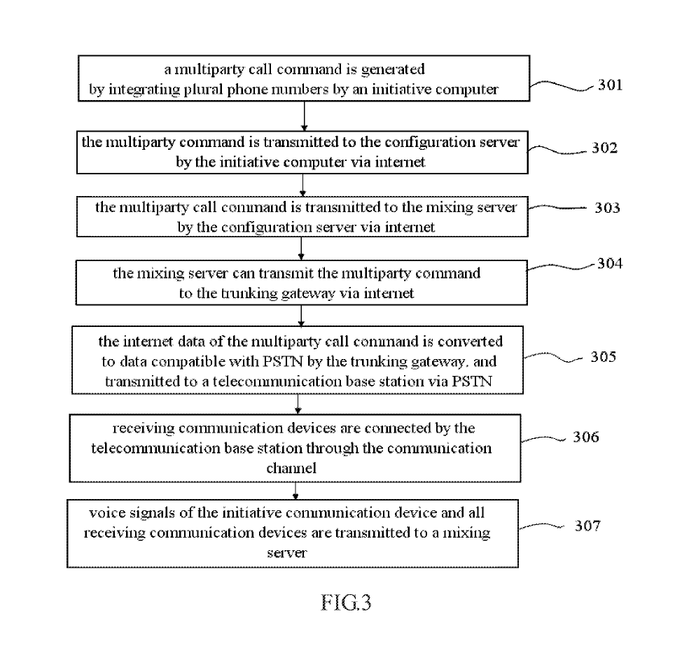

Referred to FIG. 3, it illustrates the embodiment of the multiparty call, and the steps are described as follows. First, in the step 301, a multiparty call command is generated by integrating plural phone numbers by an initiative computer. Specifically, a PC, a notebook, or a tablet computer can be employed to select plural phone numbers and integrate those numbers to a multiparty call command. For instance, particular phone numbers in the address book software can be selected, and the command of “holding a multiparty call” can be selected subsequently. Next, in the step 302, the multiparty command is transmitted to the configuration server by the initiative computer via internet. In some embodiments, the configuration server can check whether the phone numbers of the multiparty call command are available, ex: checking whether those numbers are dead lines or not. Then, in the step 303, the multiparty call command is transmitted to the mixing server by the configuration server via internet for requesting the mixing server to hold the multiparty call. In some embodiments, if the phone to be connected is a network communication device compatible with SIP, such as the internet phone, or the Wifi cell phone, it can be connected to the mixing server directly; if the phone doesn't comply with SIP, such as the softphone of google talk or skype, it can be connected to the mixing server through the network gateway for transmitting voice signals to the mixing server to subsequently be mixed. Next, in the step 304, the mixing server can transmit the multiparty command to the trunking gateway via internet. Then, in the step 305, the internet data of the multiparty call command is converted to data compatible with PSTN by the trunking gateway, and then is transmitted to a telecommunication base station via PSTN. Later, in the step 306, a plurality of receiving communication devices are connected by the telecommunication base station through the communication channel according to the multiparty call command. Any ordinary person skilled in the art should understand that the communication channel may include the wired channel and the wireless channel. If the receiving communication device is a wired phone, such as: a local telephone, the wired channel can be introduced to connect it; if the receiving communication device is a wireless communication device, such as a cell phone, a smart phone, or a PDA, the wireless channel can be introduced to connect it. Last of all, in the step 307, voice signals of the initiative communication device and all receiving communication devices are transmitted to a mixing server for mixing, so that the initiator and plural receivers can process a multiparty lines communication. It has to be noted that the initiator raising the multiparty call by the computer in the embodiment may just be an initial emcee, rather than a conferee, and thus, the initiative communication device may not participate the conference, or be kept in the conference throughout. For example, a businessman may request the secretary of the assistant to launch a multiparty call for facilitating to hold a conference with clients, cooperators, or executers, etc. In this case, the secretary or the assistant can be regarded as an initiator, and the businessman can be regarded as one receiver. The secretary or the assistant can send a multiparty call command by the initiative computer to receiving communication devices. When every receiving communication device 106 is connected successfully, the secretary or the assistant can transmit voice to the mixing server by the initiative communication device for mixing and then facilitating to emcee the conference. Afterwards, when the conference is processing, the connection between the initiative communication device and the mixing server can be cut off, so as to keep confidential during the conference call.

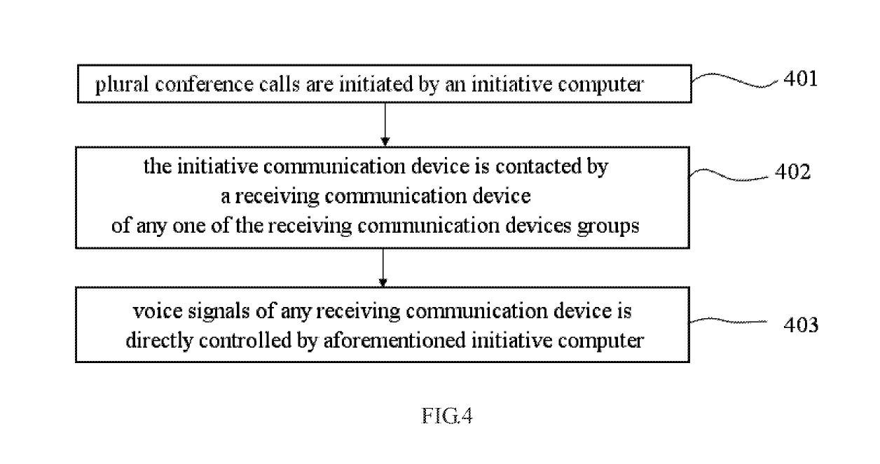

Referred to FIG. 4, it illustrates a method for managing a plurality of conference calls, and the steps are described in the following. First, in the step 401, plural conference calls are initiated by an initiative computer, whereby connecting a plurality of receiving communication devices groups. The operation method of the conference call is similar to the embodiment in the FIG. 3, the difference between them is that the initiative computer may send plural multiparty call commands in the current embodiment, and may respectively contact those receiving communication devices groups corresponding to the multiparty call commands. In this case, every receiving communication devices group individually contains a plurality of receiving communication devices to be contacted. To phrase another words, the initiative computer can raise plural multiparty call commands, and can process each multiparty call in the mean time. Further, the communication devices in each receiving communication devices group would not hear the conversations from other receiving communication devices groups, thereby facilitating to processing plural and independent conference calls simultaneous.

Next, in the step 402, the initiative communication device is contacted by a receiving communication device of any one of the receiving communication devices groups, so as to allow the initiative communication device to join the corresponding conference call. Specifically, the receiving communication device can use DTMF technology to input particular commands, whereby calling the initiative communication device. Moreover, if the receiving communication device is a smart phone or a PDA, the interface thereof can be employed to directly call the initiative communication device. For example, the representative icon can be clicked on the GUI (Graphical User Interface, GUI) of the smart phone. Eventually, in the step 403, the voice signals of any receiving communication device can be directly controlled by aforementioned initiative computer. In other words, the initiator may receive the receiver's instruction and then operate the initiative computer according to the instruction, whereby controlling voice signals of the receiving communication device, thereby achieving the purpose of managing the multiparty calls.

In some embodiments, the conferees' latest status can be transmitted to each communication device by the configuration server through DTMF. For example, if one conferee is off line, the configuration server may transmit corresponding signals in DTMF to the other conferees' communication devices, followed by those communication devices can recognize those signals and convert to a message such as “xx is off line” by the processor, software, or program in those communication devices.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A method for managing a multiparty call, including steps of:
initiating a multiparty call by an initiative computer, whereby connecting a plurality of receiving communication devices;
calling an initiative communication device by any one of said plurality of receiving communication devices to allow said initiative communication device join said multiparty call; and
controlling voice signals of any one of said plurality of receiving communication devices by said initiative computer.

2. The method according to claim 1, wherein any one of said plurality of receiving communication devices connects said initiative communication device through DTMF (Dual-Tone Multi-Frequency).

3. The method according to claim 1, wherein any one of said plurality of receiving communication devices includes a smart phone, or a PDA.

4. The method according to claim 3, further comprising a step of directly controlling voice signals of other said plurality of receiving communication devices by said any one of said plurality of receiving communication devices via an user interface.

5. The method according to claim 3, wherein the step of initiating said multiparty call comprises:
integrating a plurality of phone numbers to a multiparty call command by said initiative computer;
transmitting said multiparty call command to a configuration server by said initiative computer via internet;
transmitting said multiparty call command to a mixing server by said configuration server via internet;
transmitting said multiparty call command to a trunking gateway by said mixing server through internet;
transmitting said multiparty call command to a telecommunication base station via PSTN (Public Switched Telephone Network);
connecting said plurality of receiving communication devices and said initiative communication device by said telecommunication device through a communication channel;
transmitting voice signals of said plurality of receiving communication devices and said initiative communication device to said mixing server for being mixed, whereby facilitating multiparty lines communication.

6. The method according to claim 5, further comprising a step of checking whether said receiving communication devices are available.

7. The method according to claim 5, further comprising a step of respectively connecting at least one receiving network communication device by said mixing server through at least one network gateway, and transmitting voice signals of said at least one receiving network communication device to said mixing server through said at least one network gateway.

8. The method according to claim 7, wherein said configuration server determines sequence of said receiving network communication device according to said multiparty call command.

9. The method according to claim 5, further comprising a step of transmitting signals representing status of said receiving communication devices to said receiving communication devices by said configuration server via DTMF.

10. A method for managing a plurality of conference calls, including steps of:
initiating a plurality of conference calls by an initiative computer, whereby connecting a plurality of receiving communication devices groups;
calling an initiative communication device by a receiving communication device of any one of said receiving communication devices groups, whereby making said initiative communication device join said corresponding conference call; and
directly controlling voice signals of any one of said receiving communication devices by said initiative computer.

11. The method according to claim 10, wherein any one of said receiving communication devices calls said initiative communication device through DTMF (Dual-Tone Multi-Frequency).

12. The method according to claim 10, wherein any one of said plurality of receiving communication devices includes a smart phone, or a PDA.

13. The method according to claim 12, further comprising a step of directly controlling voice signals of other said plurality of receiving communication devices by said any one of said plurality of receiving communication devices via an user interface.

14. The method according to claim 10, wherein the step of initiating said plurality of conference calls comprises:
transmitting a plurality of multiparty call commands to a configuration server via internet;
transmitting said plurality of multiparty call commands to a mixing server by said configuration server via internet;
transmitting said plurality of multiparty call commands to a trunking gateway by said mixing server through internet;
transmitting said plurality of multiparty call commands to a telecommunication base station by said trunking gateway via PSTN (Public Switched Telephone Network);
connecting said plurality of receiving communication devices groups respectively by said telecommunication device through a communication channel;
transmitting voice signals of each receiving communication device to said mixing server for being mixed, whereby facilitating said plurality of conference calls;
wherein each of said receiving communication devices groups includes a plurality of receiving communication devices.

15. The method according to claim 14, further comprising steps of respectively connecting at least one receiving network communication device by said mixing server, and transmitting voice signals by said at least one receiving network communication device to said mixing server for being mixed.

16. The method according to claim 15, wherein said configuration server determines sequence of said receiving network communication device according to said multiparty call command.

17. The method according to claim 14, further comprising a step of transmitting signals representing status of said receiving communication devices to said receiving communication devices by said configuration server via DTMF.
